(19) United States
(12) Patent Application Publication
(10) Pub. No.: US 2019/0230085 A1
(43) Pub. Date: Jul. 25, 2019

(54) SYSTEM FOR ENCODING AND PRINTING SMARTCARDS REMOTELY

(71) Applicant: Joseph E Colston, (US)

(72) Inventor: Joseph E. Colston, Oceanside, CA (US)

(73) Assignee: Joseph E Colston, Oceanside, CA (US)

(21) Appl. No.: 15/730,723

(22) Filed: Oct. 11, 2017

(51) Int. Cl. H04L 29/06; G06K 19/077; G06K 19/073; G06K 19/07

(52) U.S. Cl. CPC H04L 63/101; G06K 19/07716; G06K 19/0723; H04L 63/104; H04L 63/0853; G06K 19/07309

(57) ABSTRACT

A system and method for encoding and personalizing smart cards from a remote location. The method includes connecting to a website or remote server and allowing the user to use remote software to encode a smart card connected to a specified client computer or RFID enabled mobile device. The server manages specialized virtual device drivers to allow users only authorized devices that are connected to the server and block access to other unauthorized devices not belonging to the locally connected user's account. The server can also control how many cards are able to be encoded for each user.

### FIELD OF THE INVENTION

The present invention is related to the smart cards, smart card encoders, smart card printers and the smart phones. More particularly it relates to the system used to encode and print the smart cards.

### BACKGROUND OF THE INVENTION

The smart cards are transaction cards which contain data about the cardholder and other related details. There are basically two types of smart cards such as contact and contactless. Both types of cards have an embedded microprocessor and memory. The processor on the smart card has an embedded operating system and can handle multiple applications such as a cash card, a pre-paid membership card, or an access control card.

The difference between the two types of smart cards is the manner with which the microprocessor on the card communicates with the smartcard readers. A contact smart card has contact points, which must physically touch the contacts on the reader to convey information between them. Since contact cards must be inserted into readers carefully in the proper orientation, the speed and convenience of such a transaction is not acceptable for most access control applications. A contactless smart card uses the same radio-based technology with a high frequency (13.56 MHz instead of 125 kHz), which allows the transfer of more data, and communication with several cards at the same time. A contactless card does not have to touch the reader and most of the access control systems read only the serial numbers present on the contactless smart cards.

With the increasing numbers of institutes and organizations in recent times, the requirement for the smartcards has increased which has to be issued to their users, customers, or employees. The smart cards have to be personalized to meet the requirements of their particular service or application. Existing smartcards which are used for transactions encode all the data in a magnetic stripe on the back of the card but the amount of data that can be held by a magnetic stripe is limited. The contactless cards can be encoded with the data on a microprocessor computer chip fit in the card which highly increases the card's data storage capacity. The chip which is fit in a smart card is generally programmed with initialization and/or personalization data at the same time as the surface of the card is being embossed and/or printed.

The initialization data which is programmed on the smartcard comprises three major types of information: application data, security data, and printed data. The application data is common to all cards for a given card application and includes application program code and variables. The security data present on the smartcard prevents illegal use of the smartcard and is usually provided in the form of secure keys. The printed data present on the smartcard such as a logo, bar codes, and various types of numerical information, are placed on the surface of the card. Some or all of the same data can also be embossed on the surface.

The current solution allows the system to encode a NFC contactless card with the help of only certain smartcard readers. They do not use a traditional smart card interface, instead they communicate with every customer conducting a question and answer session to know the needs of every customer. They do not provide any support for proximity cards and contact smart cards. They also do not provide the support for smartcard or mag stripe card printing.

The prior art which uses the traditional method for encoding and printing smartcards requires the customer or user to buy new blank smart cards from a manufacturer which comes as a pack of 50 or more smartcards. The blank white smart cards, the contactless cards or the contact chips are the cards that would be initialized with no personalized data. In order to encode and print the cards, the user would have to buy a smart card reader which also has the encoding feature in it, a smart card printer which may have an optional encoder inside and a smart card encoding software that was compatible with the smartcards to be printed.

In existing systems, the user has to install the device driver of smartcard reader which has been purchased, install the purchased smartcard encoding software which is very expensive and works only for a single computer system and install the device driver for the smartcard printer and any other related software needed for the working of the system. After all these preparations, the user can encode and print the smartcards from the computer in which the drivers and software has been installed.

Therefore, there is a need for a system for encoding and printing smartcards which allows complete personalization of card by which any type of data can be encoded using the customer's own equipment, without the requirements of installing device drivers, configuring and installing software and where the user can install their smartcard equipment on any PC, laptop, or compatible smart phone and perform complete encoding and personalization services at any location with low cost.

### OBJECTS OF THE INVENTION

The object of the present invention is to provide a system for encoding and printing smartcards using smartcard encoder and printer across the internet or over a network.

Another object of the present invention is to provide a smartcard encoding and printing system which can operate without the need for installing device drivers, smartcard encoding and printing software every time on a computer when different smartcards have to be processed.

Another object of the present invention is to provide a smartcard encoding and printing system which can be used to print unlimited number of cards of different shape and size.

Another object of the present invention is to provide a smartcard encoding and printing system which allows complete personalization of the smartcards based on the requirement of the user.

Another object of the present invention is to provide a smartcard encoding and printing system wherein the smartcards can be personalized, encoded and printed using a smartphone using an online interface.

### SUMMARY OF THE INVENTION

The present invention relates to a system which comprises of a system for encoding and printing the smartcards. The smartcard reader used in the present invention can be used also as an encoder which can be operated without installing the device drivers required for the operation of the system. The process of encoding and printing smartcards can be carried out without having to install the smartcard encoding software or printing software.

The present invention enables the users to encode the smartcards which are of different types and comes in different sizes without any prior knowledge of the card's technical information in less time. The users are also not required to pay for the expensive software which is different for different cards as same software can be used for the smartcards of all types, sizes and shapes.

For using the present invention, the user has to buy a set of blank smartcards, and either a smartcard reader or a smart card printer. The smartcard reader and the smartcard printer have to be connected to the computer system. With the help of internet facility, the user has to visit a website. The user has to register themselves onto the website once for daily access.

After registration, an account of the user will be created into which the user can carry out a one-time small download of a virtual device driver which automatically runs as the background process on the computer system, laptop or smartphone of the user. With the help of the installed device driver, the cloud server (web server) identifies the computer system, laptop or smartphone of the user and can connect to the user's smartcard equipment directly during encoding and personalization.

Since the actual device drivers and encoding and printing software needed for encoding and printing are stored on the network server, and not on the client's machine, the client can choose any network connected computer device to perform encoding and printing. The user can personalize the card accordingly by providing all the necessary data to the website interface to be encoded and printed. Once the printing of smartcards is done, the user can detach the hardware components like the reader and printer which can be used with other systems also having different operating systems like Windows, MAC and Linux etc. The user can attach the same hardware components any time to proceed with the encoding and printing smartcards.

An additional embodiment of the present invention is that it enables the web server software to print directly to the client's smartcard printer based on the designs and data provided by the client.

Another embodiment of the present invention describes that the system can also be used as a testing tool wherein a few cards can be created or printed for small development which is more cost effective than the traditional method which would cost hundreds to thousands for a few cards. The present invention also enables printing of only few smartcards which can be initially tested before printing the smartcards in mass quantities.

Another embodiment of the present invention describes that the system can be used by smartcard developers during the production of smartcard based applications. The smartcard based applications can be developed and tested with the help of the present system and they can also be improvised by making modifications in the applications.

Another embodiment of the present invention describes that the system can be used by the smartcard manufacturers and distributors who might not have any equipment and software required for encoding or printing the smartcards. They can directly register onto the website which provides them the required elements to begin encoding and printing the cards on automation machines.

In comparison with the previous attempts, the present invention supports more than one smartcards and more than one card readers but the prior art supports only one card and only one reader. The present invention supports many contactless cards but the prior art claims that it supports three contactless cards and readers. The present invention also enables the ability of the printers to print or laser graphics on both the front and back sides of the smartcards whereas the previous attempts have no ability to include printing services across the web.

### DRAWINGS

### BRIEF DESCRIPTION OF THE DRAWINGS

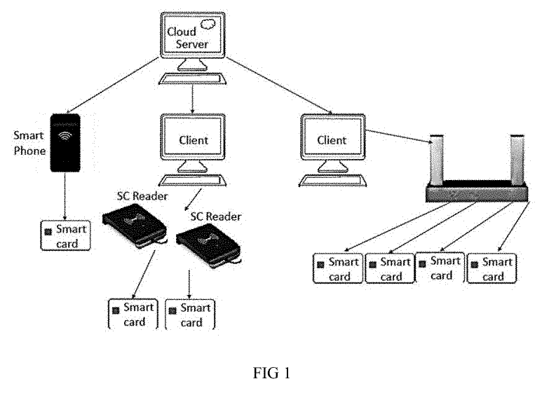

FIG. 1 describes the smartcard encoder and smartcard printer system.

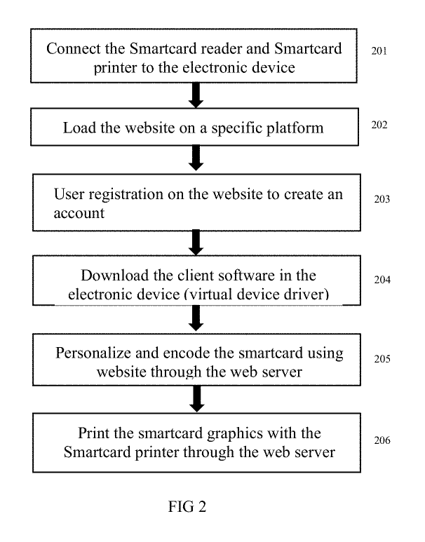

FIG. 2 is the flowchart disclosing the working of the present invention.

### DETAILED DESCRIPTION OF THE INVENTION

The present invention relates to a smartcard encoder and printer system which operates without installing the manufacturer software, device drivers, smartcard encoding software and printing software required for the operation of the system.

The process involved in the working of the present invention includes connecting the smartcard reader and printer to the computer system, laptop or a smartphone. The user has to load a website on a specific platform. The user has to register themselves in the website which creates a unique account of every user. Then the user has to download a small client software one time in the computer system, laptop or smartphone which runs as a background process and functions as a virtual device driver in the system. The website directly controls the smartcard encoder and printers which are connected to the user's system. Using the website interface, the user can encode and personalize the smartcard with desired values. The smartcard can be encoded or printed from any location with internet or network access.

As every smartcard has to be encoded in a different way, different prewritten software has to be purchased for it. To overcome this problem, the present invention provides a system through which the smart cards of different types and sizes can be encoded and printed. In addition to this, the smartcard graphics can be printed directly on the smartcard through software hosted on the webserver that talks directly to the client's hardware through the previously installed client software that functions as a virtual device driver.

As illustrated in FIG. 1, the cloud server comprises of all the necessary device drivers and software needed to encode and print the smartcards. In one embodiment of the present invention, the computer system or laptop can be connected to the cloud server with the help of a website. The smartcard reader which has encoding abilities can be connected to the computer system or laptop which are controlled by the website. The user can encode and personalize the smartcards on the website and then have their cards encoded and printed. Also the smartcards can be added with graphics on both sides of the smartcard.

In another embodiment of the present invention as illustrated in FIG. 1, the computer system or laptop which is connected to the cloud server can be connected to the smartcard printers and the smartcards of different sizes and shapes can be printed.

In another embodiment of the present invention as illustrated in FIG. 1, the website can be loaded onto a smartphone which can be connected to the smartcard printer or encoder through a USB cable. The website would then be able to control the connected smartphone's hardware and the smartcard can be personalized and printed directly.

The present invention uses the technology of a virtual device driver which allows software hosted on one computer to talk to hardware installed across the internet elsewhere. The present invention also provides additional and optional features wherein the users or customers can create their own server on the internet, or hosted locally without the need for internet service which allows them to install their own server on their local network and use it without any limitation on encoding and printing the smartcards. The server contains various encoding templates, tools to customize card data and when the user wants to use the technology, the server performs user authentication and manages the encoding processes directly to the client computer's hardware.

FIG. 2 is the flowchart disclosing the working of the present invention. Referring to FIG. 2, the process of encoding and printing the smartcards is illustrated which involves the following steps. The process starts by connecting the smartcard reader and printer to the electronic device i.e. computer system, laptop or a smartphone 201, followed by loading the website on a specific platform 202. After loading the website on the specific platform in the user's electronic device, the user has to register themselves in the website to create their unique account 203. Once the user gains access to their account, through the account they can download any client software in the electronic device i.e. computer system, laptop or smartphone which acts as a virtual device driver 204. Using the client software, the user can personalize and encode the smartcards by using the website interface through the web server 205. The final step of the process would be printing the smartcards with the help of the smart card printer from any location using internet or network access 206.

The present invention uses RFID technology for encoding and printing of the smartcards. The unique aspect of the present invention is the use of webserver or remote server, which enables encoding the smartcard. The system requires the webserver to carry out all the processes. This feature allows the user to make use of the complex encoding/printing software that runs in the cloud, and can encode the code on the smartcard directly.

The present invention has various advantages in that there are currently no websites which offer the ability to encode a proximity card through a website interface. The website can interact and directly encode a user's proximity smartcard. The present invention allows a user to use a website or network interface to have their proximity smartcard encoded by a remote website service.

Another advantage of the present invention is that there is currently no website that offers the ability to work with smartcard printers to encode and or print to the front and back of the smartcard using a smartcard printer remotely through a website interface.

Another advantage of the present invention is that an online interface can be used to personalize their card and with the payment of the nominal fee per card and proceed with the printing of the smartcard. The proposed system is completely cost effective because the cloud server comprises of the information to encode, personalize and print smartcards. Otherwise the customers would have to purchase the smartcard encoding and the smartcard printing software which can cost thousands of dollars.

Yet another advantage of the present invention over previous attempts is that the hardware drivers are not required to be installed for the smartcard readers, printers or any other hardware on the customer's or client's equipment. Once the client installs the virtual device driver, the server software recognizes the physical USB devices directly which frees the customer from complications involved with installing software and device drivers per device which is time consuming and expensive.

Yet another advantage of the present invention over traditional methods is that the system used in the present invention allows the user to print the smartcards directly from the customer or user's printer through the web interface and also for printing of the smartcards, there is no need to install any additional printing software for the end user.

Another advantage of the present invention is that the customer need not have to spend a lot of money if they want to encode only a few number of smartcards. The customers may not have to purchase the software and equipment only for encoding a few cards.

Yet another advantage of the present invention is that the system can be used by the smartcard developers during the production of smartcard based applications. The developed smartcard applications can be used by the smartcard manufacturers and smartcard distributors who have not yet built the software to handle high tech smartcards which would typically take months to years to develop.

Yet another advantage of the present invention is that the system can be used to encode contact and contactless smartcards directly from the customer or user's computer, laptop or smartphone without needing the encoding software to be installed to the local system. The software is hosted remotely on a website and performs the needed actions directly.

Yet another advantage of the present invention is that the system can be used to encode and print proximity cards as currently there is no website service available for the same.

Yet another advantage of the present invention is that the system can be used to encode and print mag-stripe cards as currently there is no website service that offer to do those services directly to the customer's cards across a web network.

Yet another advantage of the present invention is that the system uses a website service that can interact directly with contact and contactless smartcards connected to a smartphone and can be used throughout the world.

I claim:

1. A system to remotely encode and print the smart cards comprising;
a. a web server
b. a printer system;
c. device drivers;
d. an electronic device i.e. computer, laptop or smartphone;
e. smart card encoding software; and
f. smart card printing software.
wherein, the smartcards can be encoded with the help of the smartcard encoding and printing software; the web server enables the user to encode the smartcard directly to the user's hardware; the electronic device i.e. the computer, laptop or smartphone etc., are in connection with the server in which the client software can be downloaded which acts as a device driver; and the printer system is used to print the smartcards.

2. A system to remotely encode and print the smart cards as claimed in claim 1,
wherein the webserver can encode the smartcard directly to the user's hardware.

3. A system to remotely encode and print the smart cards as claimed in claim 1,
wherein the device drivers are located in the cloud server, which also contains the software needed to encode and print the smartcards.

4. A system to remotely encode and print the smart cards as claimed in claim 1,
wherein the electronic device i.e. the computer system or laptop can be connected to the cloud server with the help of a website.

5. A system to remotely encode and print the smart cards as claimed in claim 1,
wherein the smart card reader has encoding abilities can be connected to the electronic device i.e. computer system or laptop, through which the smart cards can be encoded and personalized directly from the website.

6. A system to remotely encode and print the smart cards as claimed in claim 1,
wherein the server comprises of various encoding templates, tools to customize smart card data, user authentication facility and the server also manages the encoding processes in the computer's hardware.

7. A system to remotely encode and print the smart cards as claimed in claim 1,
wherein the website from where the smart card can be encoded, can be loaded onto a smartphone which is in connection with a smartcard printer or encoder, which enables the website to control the smartphone's hardware and also personalize and print the smartcard.

8. A system to remotely encode and print the smart cards as claimed in claim 1,
wherein the smartcards can be encoded and printed from any remote location but in this case it would be printing and also encoding, which would be a novel use in conjunction with encoding at the same time

9. A system to remotely encode and print the smart cards as claimed in claim 1, wherein the system provides additional and optional features which allows the
users to create their own server on the internet, or host locally without requiring the internet service, which allows them to install their own server on their local network and encode and print the smartcards.

10. The process involved in remotely encode and print the smart cards comprising;
a. connecting the smartcard reader and printer to the electronic device i.e. computer system, laptop or a smartphone;
b. loading the website on a specific platform and registering themselves in the website by the user, which creates a unique account of every user;
c. downloading a client software in the electronic device i.e. computer system, laptop or smartphone which acts as a virtual device driver;
d. encoding and personalizing the smart cards by using the website interface through the web server; and
e. printing the smartcard with the help of the smart card printer from any location using internet or network access.

11. A system to remotely encode and print the smart cards as claimed in claim 1, wherein the smart cards of different types and sizes can be encoded and printed.

12. A system to remotely encode and print the smart cards as claimed in claim 1,
wherein the graphics can be printed directly on the smartcard through software hosted on the webserver, which communicates directly with the user's hardware through the previously installed client software.

13. A system to remotely encode and print the smart cards as claimed in claim 1,
wherein the system has the ability to encode a proximity card through a website interface, where the website can interact and directly encode a user's proximity smartcard.

14. A system to remotely encode and print the smart cards as claimed in claim 1,
wherein the system can encode and/or print both the front and back of the smartcard using a smartcard printer remotely through a website interface.

15. A system to remotely encode and print the smart cards as claimed in claim 1,
wherein the system can be used to encode both the contact and contactless smartcards directly from the user's electronic device i.e. computer, laptop or smartphone without the requirement of installing the encoding software in the local system.

16. A system to remotely encode and print the smart cards as claimed in claim 1,
wherein the system can also be used to encode and print mag-stripe cards as currently directly across a web network.
